(19) United States
(12) Patent Application Publication
(10) Pub. No.: US 2021/0018135 A1
(43) Pub. Date: Jan. 21, 2021

(54) HEAT-INSULATING BODY, HEAT-INSULATING SHEET USING SAME, AND METHOD FOR MANUFACTURING HEAT-INSULATING BODY

(71) Applicant: Panasonic Intellectual Property Management Co., Ltd., Osaka (JP)

(72) Inventors: CHIHIRO SATOU, Osaka (JP); RYOSUKE USUI, Hokkaido (JP)

(21) Appl. No.: 16/955,889

(22) PCT Filed: Mar. 11, 2019
(86) PCT No.: PCT/JP2019/009556

§ 371 Date: Jun. 19, 2020

(30) Foreign Application Priority Data
Mar. 30, 2018 (JP) 2018-067343

(51) Int. Cl. F16L 59/02; C01B 33/16

(52) U.S. Cl. CPC F16L 59/02; C01B 33/16

(57) ABSTRACT

An object of the present invention is to provide a thermal insulator which is easily position-adjusted when disposed in equipment. A plurality of projections are provided on at least one surface of thermal insulator including nonwoven fabric and xerogel in interior spaces of nonwoven fabric. With this configuration, fine positioning or the like is easily performed when thermal insulator is disposed, and a thickness increases by a height of projections, so that a thermal insulation effect can be improved. Thus, the thermal insulator can be used for thermal insulation of various types of equipment.

### TECHNICAL FIELD

The present disclosure relates to a thermal insulator to be used for thermal insulation, a thermal insulation sheet using the thermal insulator, and a method for manufacturing a thermal insulator.

### BACKGROUND ART

In recent years, there has been a great demand for energy saving, and methods for achieving the energy saving include improvement of energy efficiency by heat-retention of equipment. To achieve the heat-retention, a thermal insulation sheet having an excellent thermal insulation effect is required. Thus, a thermal insulator may be used in which silica xerogel is carried on a nonwoven fabric to make the coefficient of thermal conductivity lower than that of air.

As prior art document information related to this technique, for example, Patent Literature 1 is known.

### CITATION LIST

### Patent Literature

### PTL 1: Unexamined Japanese Patent Publication No. 2011-136859

### SUMMARY OF THE INVENTION

However, the thermal insulator has a basically flat structure, and therefore when an attempt is made to adjust a position of the thermal insulator in equipment, the position adjustment may be difficult to perform because the thermal insulator is stuck on an area where the thermal insulator has been initially placed.

In order to solve the above-described problem, the thermal insulator of the present disclosure includes a nonwoven fabric carrying xerogel in interior spaces, and a plurality of projections provided on at least one surface of the nonwoven fabric.

With the above-described configuration, it is possible to obtain a thermal insulator and a thermal insulation sheet which are easily position-adjusted, and a thermal insulation effect can be enhanced by means of the projections.

### BRIEF DESCRIPTION OF DRAWINGS

FIG. 1 is a sectional view of a thermal insulator according to an exemplary embodiment of the present disclosure.

FIG. 2 is a top view of the thermal insulator according to the exemplary embodiment of the present disclosure.

FIG. 3 is a sectional view of another thermal insulator according to the exemplary embodiment of the present disclosure.

FIG. 4 is a sectional view of a thermal insulation sheet according to the exemplary embodiment of the present disclosure.

FIG. 5 is a sectional view of another thermal insulation sheet according to the exemplary embodiment of the present disclosure.

### DESCRIPTION OF EMBODIMENT

Hereinafter, a thermal insulation sheet according to an exemplary embodiment of the present disclosure will be described with reference to drawings.

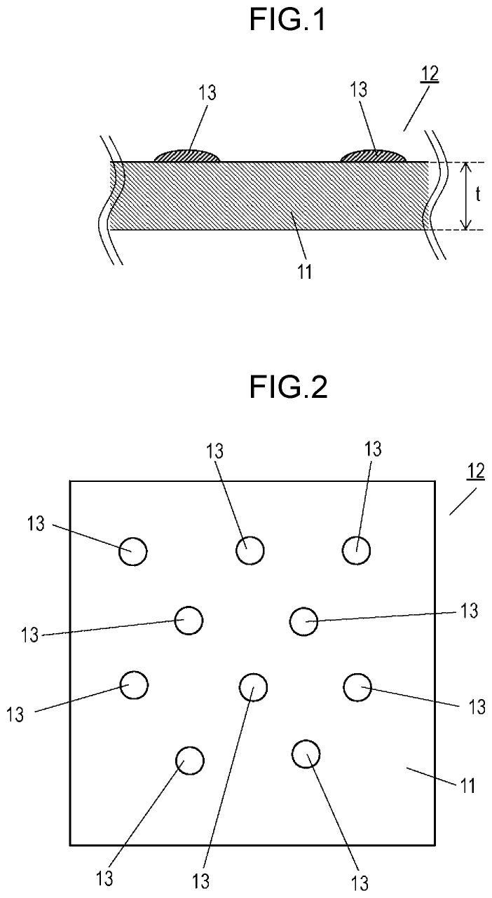

FIG. 1 is a sectional view of a thermal insulator according to an exemplary embodiment of the present disclosure, and FIG. 2 is a top view of the thermal insulator according to the exemplary embodiment of the present invention.

Thermal insulator 12 is formed by carrying silica xerogel (not shown) in spaces of nonwoven fabric 11 made of polyethylene terephthalate (hereinafter, referred to as PET) having spaces inside the PET. Nonwoven fabric 11 includes PET fiber having an average fiber thickness of about 10 μm, and the spaces occupy about 90% of nonwoven fabric 11. Since this silica xerogel has nano-sized spaces inside the silica xerogel, a coefficient of thermal conductivity of a part filled with the silica xerogel is 0.018 to 0.024 W/m·K, smaller than a coefficient of thermal conductivity of air. The silica xerogel is broad-sense xerogel with the gel being in a dried state, and may be obtained not only by ordinary drying but also by supercritical drying, freeze drying or the like.

Here, thermal insulator 12 has a thickness of about 0.3 mm and a size of about 100 mm square. One surface of thermal insulator 12 is provided with projections 13 formed by raising a part of the surface. Projections 13 have a height of about 0.03 mm from the one surface, and a diameter of about 3 mm, and are arranged in such a manner that a shortest distance between centers of projections 13 is about 15 mm.

This ensures that when the surface provided with projection 13 is placed at an installation position, contact occurs only with the projections, and therefore the thermal insulator is prevented from sticking at the installation position. Thus, fine positioning or the like is easily performed. Further, a thickness increases by the height of projections 13, so that a thermal insulation effect can be improved.

Preferably, the height of projections 13 ranges from 0.05 t to 0.15 t inclusive, where t is a thickness of thermal insulator 12. This is because when the height is less than 0.05 t, an effect of an invention according to the present disclosure is reduced, and when the height is more than 0.15 t, it is difficult to maintain a shape.

Preferably, projections 13 are arranged in such a manner that a shortest distance between projections 13 ranges from 30 t to 80 t inclusive, where t is the thickness of thermal insulator 12. This is because when the distance is less than 30 t, a contact area increases, resulting in reduction of the effect of the invention according to the present disclosure, and when the distance is more than 80 t, thermal insulator 12 bends, resulting reduction of the effect of the invention according to the present disclosure.

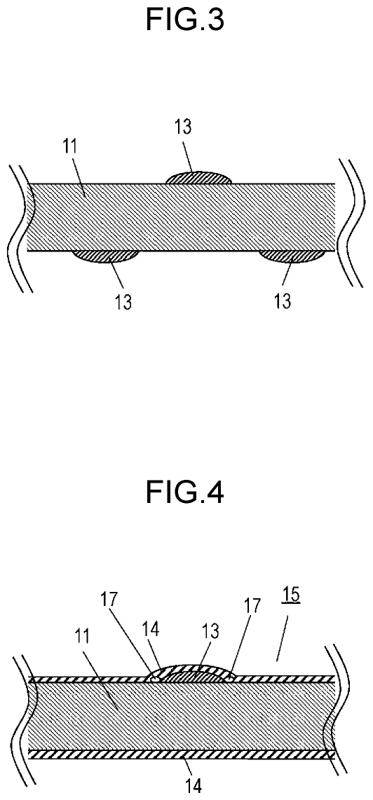

Projections 13 may be provided on both surfaces of thermal insulator 12 as in FIG. 3. In this case, it is preferable that positions of projections 13 are different between both surfaces. When projections 13 are provided on thermal insulator 12, strain easily occurs near projections 13, and therefore it is preferable that positions of projections 13 are different between both surfaces.

FIG. 4 is a sectional view of a thermal insulation sheet using the thermal insulator according to the exemplary embodiment of the present disclosure. Thermal insulator 12 is formed by carrying silica xerogel in spaces of a nonwoven fabric made of PET having spaces inside the PET as in FIG. 1. Thermal insulator 12 has a thickness of about 0.3 mm, and projections 13 having a height of about 0.03 mm are arranged in such a manner that the shortest distance between centers of projections 13 is about 15 mm. Thermal insulation sheet 15 is formed by wholly covering thermal insulator 12 with insulating film 14 having a thickness of about 0.01 mm and made of PET. By covering thermal insulator 12 with insulating film 14 having a thickness smaller than the height of projection 13, insulating film 14 can be deformed along a surface of thermal insulator 12, so that it is possible to obtain a thermal insulation sheet 15 which hardly sticks at an installation position. Very small spaces 17 are formed around projection 13, and confined in insulating film 14, so that the thermal insulation effect can be further improved.

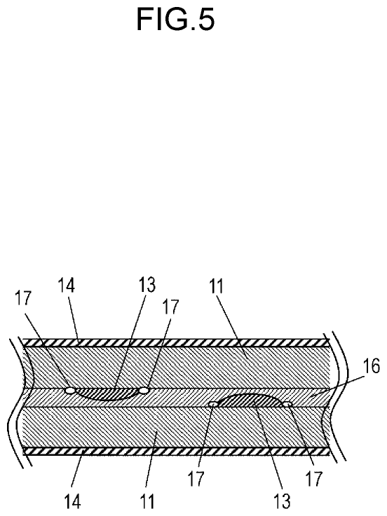

FIG. 5 is a sectional view of another thermal insulation sheet using thermal insulator according to the exemplary embodiment of the present disclosure. Two thermal insulators 12 are superposed, and wholly covered with insulating film 14 to form thermal insulation sheet 15. Projections 13 are provided on all opposite surfaces of thermal insulators 12, and an insulating sheet 16 is sandwiched between thermal insulators 12. It is more preferable that positions of projections 13 provided on opposite surfaces are mutually different. Preferably, a sheet impermeable to air, such as a PET sheet, is used as insulating sheet 16. With this configuration, a space in a region sandwiched between thermal insulators 12 are separated by insulating sheet 16, and thus thermal conduction caused by convection of air can be prevented, so that the thermal insulation effect can be further improved.

Next, a method for manufacturing the thermal insulator according to the exemplary embodiment of the present disclosure will be described.

First, a nonwoven fabric made of PET having a thickness of about 0.3 mm is prepared. This nonwoven fabric is immersed in a sol solution obtained by, for example, adding hydrochloric acid to a sodium silicate aqueous solution, so that the interior spaces of the nonwoven fabric are impregnated with the sol solution. The sol solution is gelled, hydrophobized and dried to fill the interior spaces of the nonwoven fabric with silica xerogel. Before the sol solution is completely dried, a surface of the nonwoven fabric is only partially suctioned under vacuum, and the suctioned part is raised to form a projection. By completely drying the nonwoven fabric, a thermal insulator having a plurality of projections on a surface of the thermal insulator can be obtained.

A size, an arrangement, a height and the like of projections can be set to a predetermined size, arrangement, height and the like according to a shape and an arrangement of holes of a vacuum suction plate.

Thereafter, two thermal insulators 12 are superposed, and wholly covered with insulating film 14. In this way, thermal insulation sheet 15 is obtained.

In the exemplary embodiment, materials of nonwoven fabric 11, projections 13 and insulating film 14 are PET, but may be resin materials other than PET. The materials of nonwoven fabric 11, projections 13 and insulating film 14 may be mutually different.

### INDUSTRIAL APPLICABILITY

The thermal insulator according to the present disclosure and the thermal insulation sheet using the thermal insulator can be easily position-adjusted, and are industrially useful.

### REFERENCE MARKS IN THE DRAWINGS

11 nonwoven fabric
12 thermal insulator
13 projection
14 insulating film
15 thermal insulation sheet
16 insulating sheet
17 space

1. A thermal insulator comprising:
a nonwoven fabric carrying xerogel in interior spaces; and
a plurality of projections provided on at least one surface of the nonwoven fabric.

2. The thermal insulator according to claim 1, wherein a height of each of the plurality of projections ranges from 0.05 t to 0.15 t inclusive, where t is a thickness of the nonwoven fabric.

3. The thermal insulator according to claim 1, wherein a shortest distance between the projections ranges from 30 t to 80 t inclusive, where t is a thickness of the nonwoven fabric.

4. The thermal insulator according to claim 1, wherein the projections are provided on both surfaces of the nonwoven fabric, and positions of the projections on the both surfaces are mutually different in plan view.

5. A thermal insulation sheet comprising:
a thermal insulator; and
an insulating film which wholly covers the thermal insulator,
the thermal insulator including a nonwoven fabric carrying xerogel in interior spaces, and a plurality of projections provided on at least one surface of the nonwoven fabric.

6. The thermal insulation sheet according to claim 5, comprising a plurality of thermal insulators each being the thermal insulator; and
an insulating sheet,
wherein the plurality of the thermal insulators are stacked while one surface of the nonwoven fabric provided with the projections is opposed to another surface provided with projections,
the insulating sheet is sandwiched between the surfaces of the plurality of thermal insulators, which are provided with the projections, and
surfaces of the plurality of thermal insulators on a side opposite to the surfaces provided with the projections are covered with the insulating film.

7. A method for manufacturing a thermal insulator, comprising:
a step of immersing in a predetermined sol solution a nonwoven fabric having spaces inside the nonwoven fabric, and impregnating the interior spaces of the nonwoven fabric with xerogel;
a step of preparing a thermal insulator by drying the nonwoven fabric impregnated with the xerogel;
a step of forming a plurality of projections by vacuum-suctioning a part of at least one surface of the nonwoven fabric when xerogel is not completely dried, and
a step of covering the at least one surface of the thermal insulator with an insulating film.
